(19) United States
(12) Patent Application Publication
(10) Pub. No.: US 2008/0001059 A1
(43) Pub. Date: Jan. 3, 2008

(54) Solar Energy Current Collection Mechanism

(76) Inventor: Chin-Wen Wang, Pingjhen City (TW)

Correspondence Address: HDSL, 4331 STEVENS BATTLE LANE, FAIRFAX, VA, 22033, US

(21) Appl. No.: 11/427,775

(22) Filed: Jun. 29, 2006

(51) Int. Cl. G01J 1/20

(52) U.S. Cl. 250/203.4

(57) ABSTRACT

A solar energy current collection mechanism with a timer and its structure includes a light collector, a retaining base and a base body. The light collector includes a base, a solar panel at the top of the base, a conical light collecting hood around the periphery of the base, a plurality of supporting stands around the light collecting hood and an axle passing though the light collecting hood. The retaining base is disposed under the light collector, and both ends of the retaining base are connected to both ends of the axle. The retaining base includes the timer connected to the axle for driving the light collector to rotate, and the retaining base is disposed on a base body, and the base body includes a control unit and a battery unit electrically connected to a solar panel for controlling and storing the electric power produced by the solar panel.

### BACKGROUND OF THE INVENTION

1. Field of the Invention

The present invention relates to an electric generating mechanism, and more particularly to a current collection mechanism that generates electricity by solar energy.

2. Description of Prior Art

Electric power supply has become an indispensable part of our life, and various different electric appliances require electric power for the operation to fulfill our needs, but a great deal of resources is abused. With the increasing population, the usable resources become insufficient, and we have to think over the problem thoroughly again and find other feasible alternate energy source, and solar energy is one of these alternate energy sources.

Solar energy is a pollution-free inexhaustible energy source, and thus solar energy has become one of the most important subjects for research. In the past, most solar energy current collectors are of the fixed type that exposes a solar panel with a large area under sunlight, and an electric generator stores the generated electric energy into a battery unit for providing power supply to users. Although such large solar panel can collect a large quantity of solar energy, an effective photoelectric conversion can be taken place at the position with sunlight or where the solar panel can receive lights. In other words, effective photoelectric conversions can be taken place from 10 am to 2 pm of a day only. If the angle of incidence of the sunlight is too large, then the solar panel cannot absorb sunlight effectively, and the performance of generating electric power by the sunlight will be lowered drastically.

To break through the foregoing limitations, some prior arts provide a sun tracking mechanism that is installed onto a solar panel and rotated synchronously with the sun by employing an electronic control mode. In the meantime, mirrors are installed around the solar panel, such that the sun tracking mechanism drives the solar panel to be aligned with the sun when the sun rises, so as to absorb the solar energy to generate electricity. In the meantime, the action of the mirrors can improve the intensity of the incident sunlight and enhance the photoelectric conversion performance.

Although the sun tracking mechanism can break through the tradition and overcome the shortcomings of the traditional fixed solar energy current collector, and the solar panel can follow the direction and position of the sun to absorb sunlight for an electric generation and generate electric power, yet the sun tracking mechanism cannot be operated anymore in a power failure since the prior art sun tracking mechanism is operated by electric power, and thus the solar energy current collector will lose its function completely in a power failure.

Further, although the solar panel for absorbing sunlight can stand the high temperature produced by the projected sunlight, yet the operating chips in the solar panel has a specific upper limit of temperature. If the sun is right up in the sky and the brightness is increased by the effect of the refection of the mirrors designed at the periphery, and no timely heat dissipation is provided for the solar panel for maintaining the operating temperature within its allowable limit, the chip inside the solar panel will be burned or damaged by the high temperature, and the effect for generating electric power by the solar panel will be reduced greatly, and all of the aforementioned issues are bottlenecks of existing sun tracking solar energy electric generators.

### SUMMARY OF THE INVENTION

In view of the foregoing shortcomings of the prior art, the inventor of the present invention based on years of experience in the related industry to conduct experiments and modifications, and finally designed a feasible solution to overcome the shortcomings of the prior art.

Therefore, the present invention to overcome the shortcomings of the prior art by providing a solar energy current collection mechanism having a timer, and the timer drives the solar panel to perform sun tracking and simplify the sun tracking device. Further, a heat sink is installed under the solar panel for protecting the solar panel from high temperature produced during its operation.

The present invention provides a solar energy current collection mechanism, the mechanism comprises a light collector, a retaining base and a base body, wherein the light collector further includes a base, and the top of the base includes a solar panel, and the bottom of the base includes a heat sink, and the rim of the base is covered by a conical light collecting hood. In the meantime, a plurality of supporting stands are disposed around the rim of the light collecting hood and having an axle and covering the light collector with a transparent hood for protecting the light collector. The retaining base is disposed under the light collector, and both ends of the retaining base are connected to both ends of the axle. The retaining base includes a timer, and the timer is connected to the axle for driving the light collector to rotate, and finally the retaining base is disposed on a base body, and the base body includes a control unit and a battery unit and is electrically coupled to the solar panel for controlling and storing electric power produced by the solar energy.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a perspective view of the present invention;

FIG. 2 is another perspective view of the present invention;

FIG. 3 is a further perspective view of the present invention;

FIG. 4 is a cross-sectional view of the structure of the present invention;

FIG. 5 is another cross-sectional view of the structure of the present invention;

FIG. 6 is a cross-sectional view of the operation of the present invention;

FIG. 7 is another cross-sectional view of the operation of the present invention;

FIG. 8 is a schematic view of the operation of the present invention; and

FIG. 9 is a perspective view of another preferred embodiment of the present invention.

### DETAILED DESCRIPTION OF THE INVENTION

The technical characteristics, features and advantages of the present invention will become apparent in the following detailed description of the preferred embodiments with reference to the accompanying drawings. However, the drawings are provided for reference and illustration only and are not intended for limiting the scope of the invention.

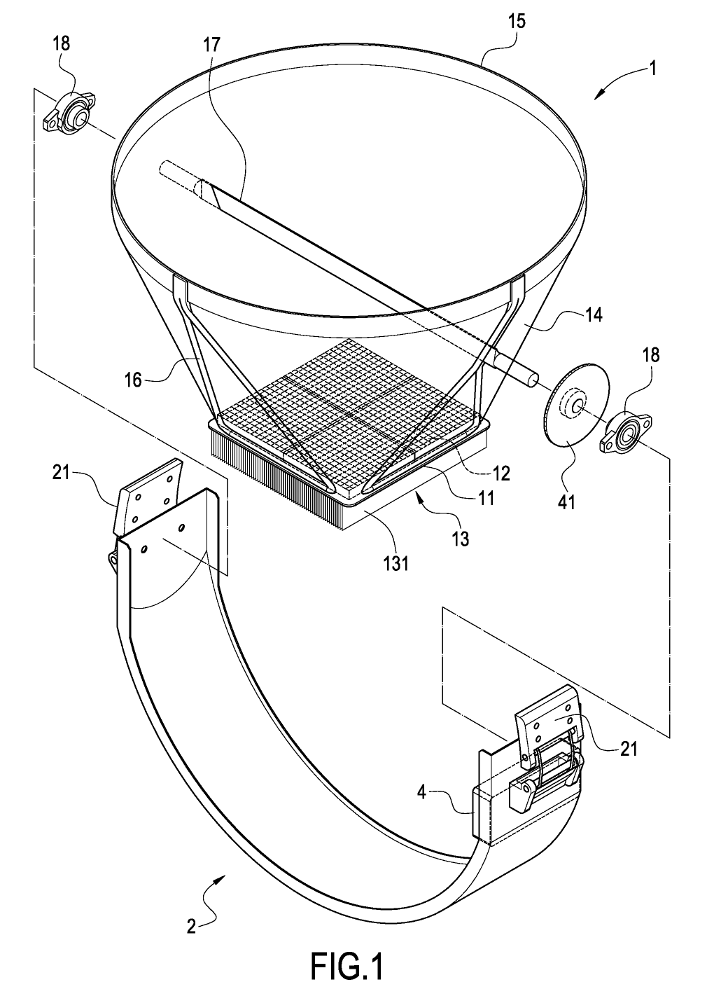

Referring to FIG. 1 for an exploded view of the present invention, the electric generating structure of the present invention comprises a light collector 1, a retaining base 2 and a base body 3, wherein the light collector 1 further includes a base 11, and an upper panel of the base 11 includes at least one solar panel 12, and the structure of the solar panels 12 of the present embodiment is comprised of four rectangular solar panels 12, and a lower panel of the base 11 includes a heat sink 13, and the heat sink 13 is comprised of a plurality of heat dissipating fins 131 with a high thermal conductivity. Further, the periphery of the base 11 is covered by a light collecting hood 14, and the light collecting hood 14 is substantially in a conical shape, and the internal side of the light collecting hood 14 is a mirror 141 for reflecting and projecting sunlight onto the solar panel 12, and the rim of the light collecting hood 14 is connected to a circular frame 15. In the meantime, a plurality of supporting stands 16 (which are four supporting stands 16 corresponding with each other as shown in the figure) are connected between the circular frame 15 and the baseboard 11 for fixing the base 111 and the circular frame 15. Further, an axle 17 is disposed on the light collecting hood 14 and coupled between two corresponding supporting stands 16, and a pivoting base 18 is connected to both ends of the axle 17; and the retaining base 2 is disposed under the light collector 1. The retaining base 2 is substantially in a semicircular arc shape when it is viewed from a lateral side, and the retaining base 2 is connected to a pivoting base 18 disposed on both left and right sides of the light collector 1, such that the light collector 1 is hung on the retaining base 2. The retaining base 2 further includes a timer 4, and the timer 4 is connected to an axle 17 through a turning disc 41 and passed through the axle 17, so that the timer 4 drives the axle 17 to rotate. Further, the retaining base 2 includes a fixing plate 21 separately disposed on both left and right sides of the retaining base 2.

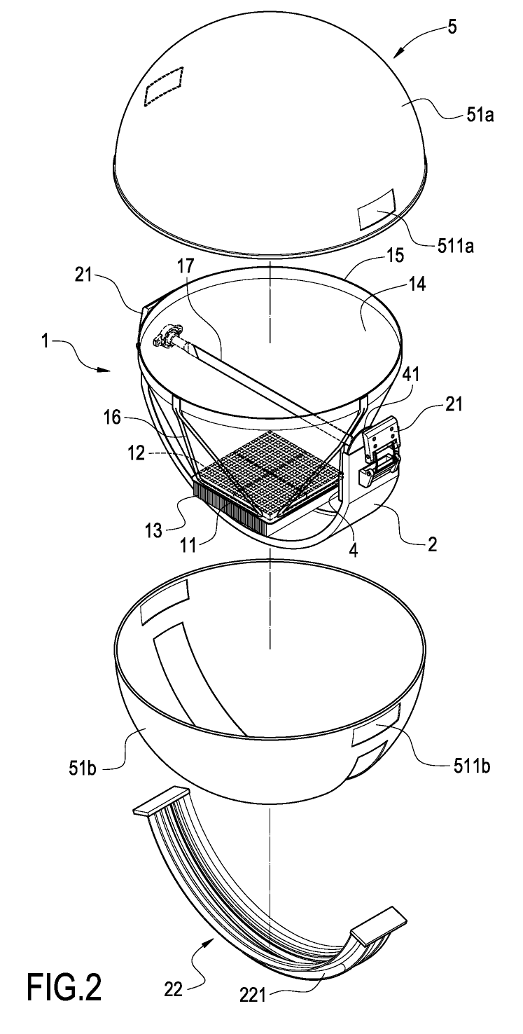

Referring to FIG. 2, a transparent hood 5 is covered onto the light collector 2 for protecting the light collector 1, and the transparent hood 5 is comprised of two hemispherical hood bodies 51a, 51b. The retaining base 2 further comprises a casing 22, and both left and right sides of the casing separately include a sliding groove 221. In the meantime, the hood bodies 51a, 51b install a plurality of through holes 511a, 511b, such that after the retaining base 2 and the fixing plate 21 are fixed to clamp the hood body 51b of the transparent hood 5 by the retaining base 2 and its casing 22, and finally the hood body 51a of the transparent hood 5 is fixed by the fixing plates 21 on both left and right sides of the retaining base 2.

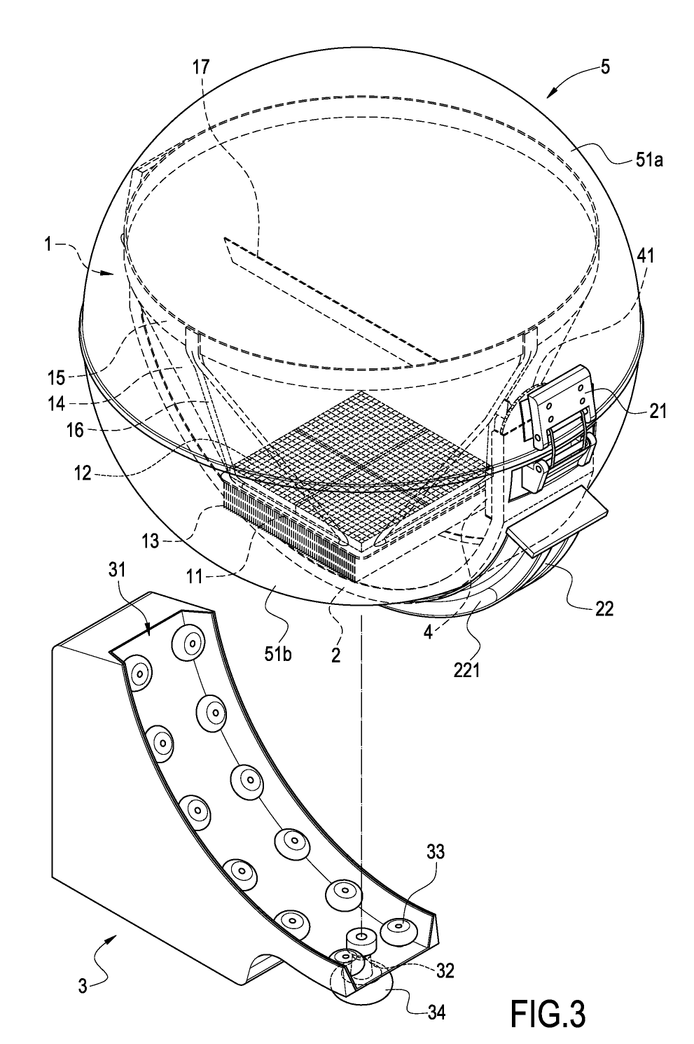

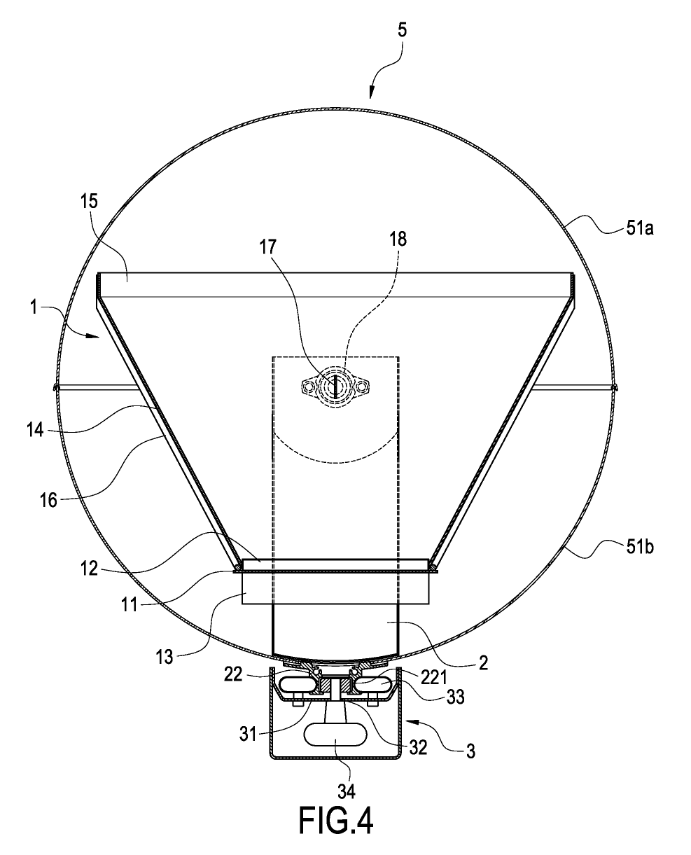

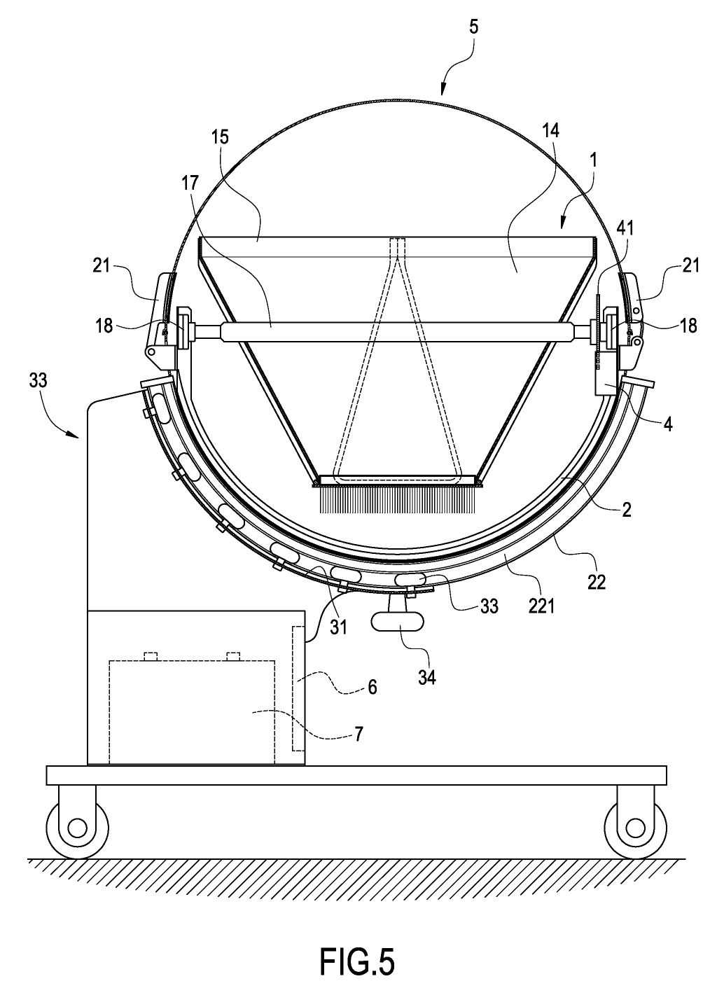

Referring to FIG. 3, the base body 3 includes a cambered surface 31, and the bottom of the center of the cambered surface 31 has a fixing hole 32, and both left and right sides of the fixing hole 32 include a plurality of rollers 33 arranged corresponding to each other and contained in the sliding grooves 221 disposed separately on both left and right sides of the casing 22 of the retaining base 2. Further, a connecting base 34 is passed through the fixing hole 32 and secured to the bottom of the casing 22 of the retaining base 2 as shown in FIG. 4, so that after the light collector 1, retaining base 2 and transparent hood 5 are connected, the plurality of rollers 33 can be slid on the base body 3 by the sliding groove 221. Referring to FIG. 5, the base body 3 includes a control unit 6 and a battery unit 7, and the control unit 6 is electrically coupled to a solar panel 12 on the light collector 1 and a battery unit 7 at the same time.

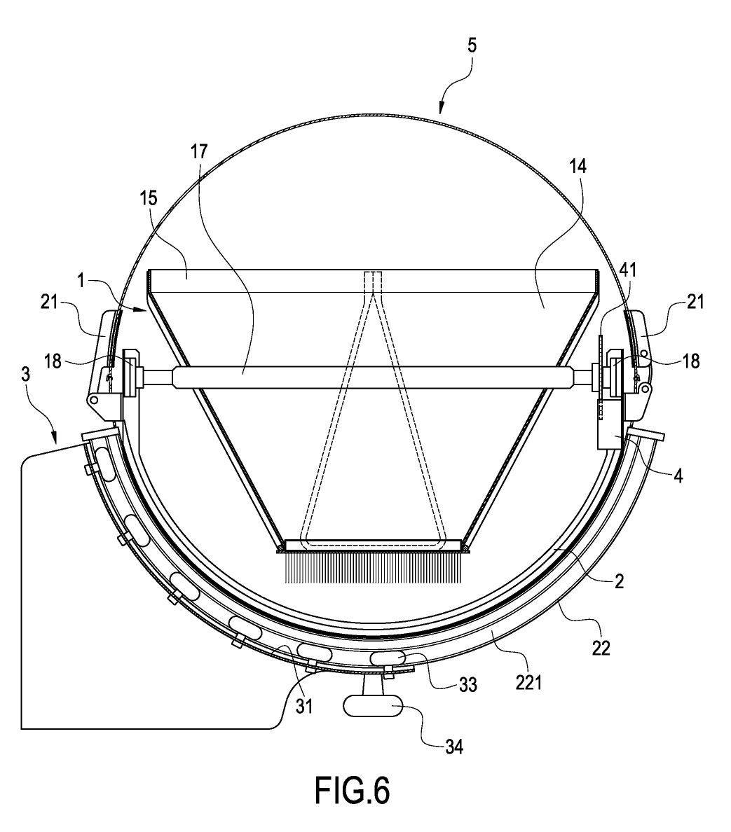

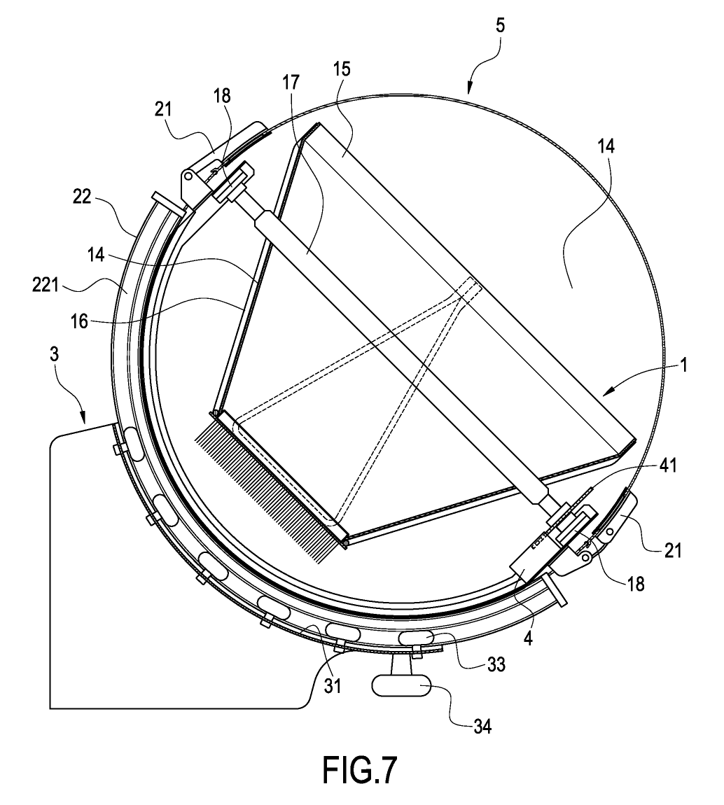

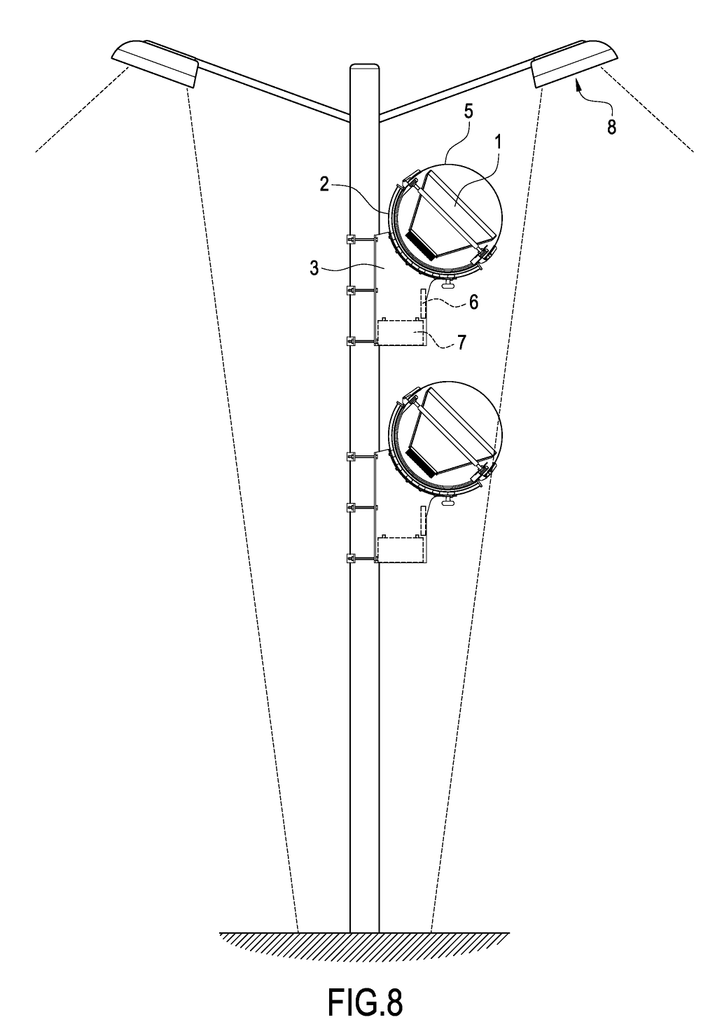

Referring to FIGS. 6 and 7 for the schematic views of the operation of the present invention, the connecting base 34 coupled between the base body 3 and the retaining base 2 is used for adjusting and fixing the position of the light collector 1 before the light collector of the invention performs sun tracking, so that the light collector 1 can be aligned with the moving path of the sun while adjusting the timer 4 and the synchronization of the moving sun. When the sun rises, the axle 17 on the light collector 1 is driven by the turning disc 41 that is connected to the timer 4 and rotated synchronously with the sun. In the meantime, the solar panel 12 on the light collector 1 is aligned precisely with the sun to absorb the solar energy produced by the sun. With the action of the light collecting hood 14 at the rim of the solar panel 12, the strength of absorbing the solar energy by the solar panel 12 is improved to enhance the performance of the photoelectric conversion of the solar panel 12, and the electric power produced by the solar panel 12 is sent to and stored into the battery unit 7 through the control unit 6. Referring to FIG. 8, the electric power stored in the battery unit 7 is supplied for the use by electronic appliances such as a streetlamp 8 as shown in the figure. With the action of the heat sink 13 installed at the bottom of the baseboard 11, the normal operation of the solar panel 12 can be maintained at the operating temperature.

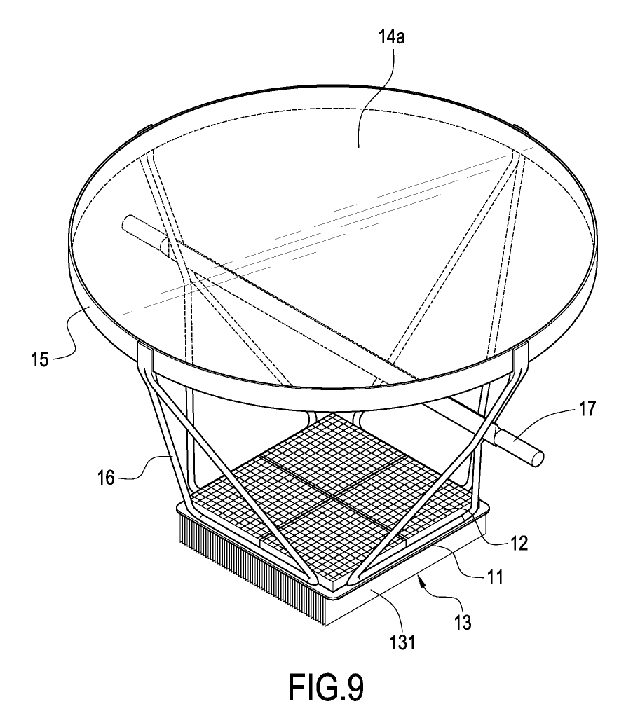

In addition to the structure of the light collecting hood 14 installed in the light collector 1 for reflecting sunlight, a thin-film magnifier 14a can be installed on the circular frame 15 as shown in FIG. 9 for collecting and projecting the absorbed sunlight onto the solar panel 12 to produce electric power by a photoelectric conversion.

In summation of the above description, the invention herein enhances the performance than the conventional structure and further complies with the patent application requirements.

The present invention are illustrated with reference to the preferred embodiment and not intended to limit the patent scope of the present invention. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A solar energy current collection mechanism, comprising:
a light collector, having a base, at least one solar panel disposed on the base, a heat sink disposed at the bottom of the base, a plurality of supporting stands disposed at the periphery of the base, a circular frame coupled to the supporting stands, an axle passed through the supporting stands, and a pivoting base pivotally coupled to both ends of the axle;
a retaining base, disposed under the light collector and both ends of the retaining base being coupled to the pivoting base;
a timer, installed on the retaining base and coupled to the axle of the light collector by a turning disc;
a control unit, electrically coupled to a solar panel of the light collector for controlling a photoelectric conversion; and
a battery unit, electrically coupled to the control unit and the light collector, for storing or discharging electric power produced by the solar panel.

2. The solar energy current collection mechanism of claim 1, wherein the base includes alight collecting hood disposed around the periphery of the base.

3. The solar energy current collection mechanism of claim 2, wherein the light collecting hood forms a mirror surface as an internal surface thereof.

4. The solar energy current collection mechanism of claim 2, wherein the light collecting hood is in a conical shape.

5. The solar energy current collection mechanism of claim 1, wherein the circular frame includes a thin-film magnifier disposed thereon.

6. The solar energy current collection mechanism of claim 1, wherein the heat sink includes a plurality of heat dissipating fins.

7. The solar energy current collection mechanism of claim 1, further comprising a transparent hood installed inside the light collector.

8. The solar energy current collection mechanism of claim 7, wherein the transparent hood includes two hemispherical hood bodies.

9. The solar energy current collection mechanism of claim 8, wherein the hood body further includes a plurality of through holes.

10. The solar energy current collection mechanism of claim 1, wherein the retaining base includes a fixing plate disposed on both ends of the retaining base.

11. The solar energy current collection mechanism of claim 10, wherein the fixing plate is passed through the through hole of the transparent hood.

12. The solar energy current collection mechanism of claim 1, wherein the retaining base further includes a casing disposed at the bottom of the retaining base.

13. The solar energy current collection mechanism of claim 12, wherein the casing includes a sliding groove disposed on both sides of the casing.

14. The solar energy current collection mechanism of claim 1, further comprising a base body with a cambered surface, a fixing hole disposed at the bottom of the cambered surface, and a plurality of rollers disposed on both sides of the fixing hole, and the roller is contained in the sliding groove of the casing, and a fixing hole is disposed on a connecting base, and the connecting base is coupled to a casing of the retaining base.
